(19) United States
(12) Patent Application Publication
(10) Pub. No.: US 2014/0132197 A1
(43) Pub. Date: May 15, 2014

(54) Electric Actuator For Automobile

(71) Applicant: Hitachi Automotive Systems, Ltd., Hitachinaka-shi (JP)

(72) Inventors: Hiroshi KANAZAWA, Hitachinaka (JP); Junnosuke NAKATSUGAWA, Hitachinaka (JP); Shozo KAWASAKI, Hitachinaka (JP); Yasunaga HAMADA, Hitachinaka (JP); Kenji NAKAYAMA, Hitachinaka (JP)

(73) Assignee: Hitachi Automotive Systems, Ltd., Hitachinaka-shi (JP)

(21) Appl. No.: 14/073,327

(22) Filed: Nov. 6, 2013

(30) Foreign Application Priority Data
Nov. 9, 2012 (JP) 2012-246993

(51) Int. Cl. H02K 3/28; H02P 6/00

(52) U.S. Cl. CPC H02K 3/28; H02P 6/001
USPC 318/724; 310/198

(57) ABSTRACT

In an electrical actuator, the number of piece of an inverter is made one in order to miniaturize a control circuit suitable to a mechanically and electrically integrate type, a motor is configured to include two independent three-phase windings thereinside, and motor relays are disposed at neutral points of the independent three-phase windings.

### BACKGROUND

The present invention relates to a connection configuration of a neutral point switch used for an electric power steering motor.

As a related art of the present technical field, there is Japanese Unexamined Patent Application Publication No. 2012-90383. According to this publication, in a structure of driving one motor with windings of two systems with different number of turns and two independent inverters, six independent relays of two systems are arranged on the input side of a three-phase winding. Also, there is Japanese Unexamined Patent Application Publication No. 2011-45212. In the publication, there is disclosed one formed of windings of two systems with same number of turns and two inverters, and with six independent relays being arranged on the input side of three-phase windings. Further, in Japanese Unexamined Patent Application Publication No. 2003-40123, there is disclosed one provided with a winding of the first system and a winding of the second system in one tooth in a configuration similar to that of Japanese Unexamined Patent Application Publication No. 2011-45212.

### SUMMARY

In all of the publications described above, the system is formed of two independent three-phase inverters, and a motor relay is disposed on the input side of the motor. Therefore, because two sets of inverters must be arranged, the control circuit unit becomes large, and it is hard to employ the system for an electric power steering motor of a mechanically and electrically integrated type. Also, because the motor relay is disposed on the input side of the three-phase windings of the motor, when phase short circuit inside the motor occurs, a short circuit is formed inside the motor even when the motor relay is disconnected, when a driver operates steering, the steering motion becomes heavy due to the short circuit current inside the motor, and uncomfortable feeling may be given to the driver.

In order to address the above-described problems, according to an aspect of the present invention, three-phase windings connected inside the motor are divided into plural three-phase winding groups, and a switching unit that disconnects the wire connection of the three-phase windings is arranged so that the respective groups function as independent three-phase windings.

According to the aspect of the present invention, even when the phase short circuit occurs in some group, a winding group where a failure has occurred can be disconnected by the switching unit, and therefore operation can be continued using remaining normal winding groups.

### BRIEF DESCRIPTION OF THE DRAWINGS

FIG. 1 is a perspective view of an electric power steering motor of a mechanically and electrically integrated type;

FIG. 2 is a perspective view of a motor unit only;

FIG. 3 is an axial cross-sectional view of the motor unit;

FIG. 4 is an explanatory drawing of the phase arrangement of the 8 pole-12 slot structure;

FIG. 5 is a circuit configuration drawing in which a motor relay is disposed at the neutral point in the 8 pole-12 slot structure;

FIG. 6A is an explanatory drawing of the phase arrangement of 8 poles-12 slots and 10 poles-12 slots;

FIG. 6B is an explanatory drawing of the phase arrangement of 8 poles-12 slots and 10 poles-12 slots;

FIG. 7A is a configuration drawing of a motor of 8 poles-12 slots;

FIG. 7B is a configuration drawing of a motor of 8 poles-12 slots;

FIG. 8A is a configuration drawing of a motor of 10 poles-12 slots;

FIG. 8B is a configuration drawing of a motor of 10 poles-12 slots;

FIG. 9 is an explanatory drawing of an example of a phase short circuit detection structure of a motor;

FIG. 10 is an explanatory drawing explaining a situation of phase short circuit detection;

FIG. 11 is a flowchart until phase short circuit is detected;

FIG. 12 is a configuration drawing showing another detection means for phase short circuit detection;

FIG. 13 is a timing chart when phase short circuit occurs; and

FIG. 14 is a configuration drawing of a motor with the triangular wire connection.

### DETAILED DESCRIPTION

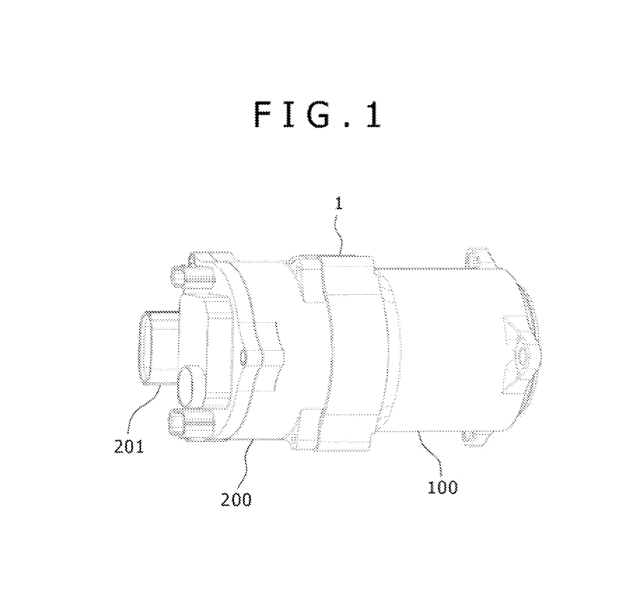

Below, embodiments will be described with reference to FIG. 1 to FIG. 14.

### First Embodiment

In the present embodiment, a mechanically and electrically integrated type electric power steering (abbreviated as EPS) motor structure will be described in which a motor and a control unit of the electric power steering motor are formed of an integrated structure.

A motor of the present embodiment is an electric actuator in which plural coils composed of a U-phase, a V-phase, and a W-phase are connected to form one three-phase winding, and the three-phase winding is formed of a circuit in which plural winding groups obtained by connecting the U-phase, the V-phase, and the W-phase with each other are connected in parallel.

In a connecting section where the windings of the respective phases of the winding groups are connected to each other, a switching unit capable of independently disconnecting the each winding group from the other winding groups is provided. By the switching unit, even when a winding group is disconnected from other winding groups, the remaining winding groups maintain the parallel connection, and therefore one three-phase winding is formed by the remaining winding groups.

By employing such a configuration, even when a failure occurs in some of the plural winding groups, a winding group where the failure occurred can be independently disconnected from the other winding groups, and therefore the motion can be continued by the remaining winding groups.

FIG. 1 shows an example of an aspect that more specifically explains a structure of an electric power steering motor of the present embodiment. A mechanically and electrically integrated type EPS motor 1 is formed of a motor unit 100 and a control unit 200. In the control unit 200, a connector 201 is arranged to which power is supplied. In the control unit 200, an inverter and a control board for driving the motor are furnished. The motor unit 100 is configured so that three-phase drive power is supplied from the control unit 200. To the right of the motor unit 100, an output shaft capable of outputting torque of the motor is arranged although it is not illustrated.

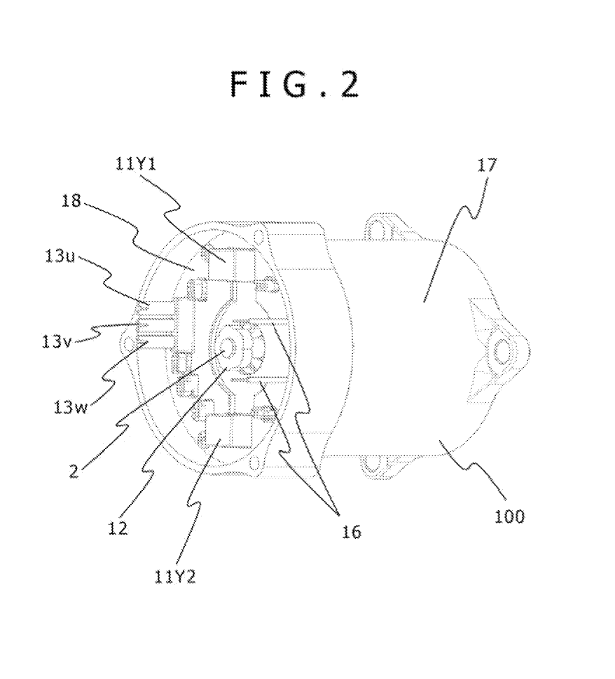

The structure of the motor unit 100 will be described in detail using FIG. 2. FIG. 2 shows a structure in which the control unit 200 of FIG. 1 described above has been removed. The motor unit 100 is formed of a stator, a rotor, and coils (not illustrated) for forming a motor inside an aluminum housing 17. Electrically connecting points to the control unit 200 are a U-phase terminal 13u, a V-phase terminal 13v, a W-phase terminal 13w connected to the three-phase winding, and power source terminals 16 for driving a relay. Two pieces of the power source terminals 16 for driving a relay are prepared so that opening/closing of two relays can be independently controlled. Because the current capacity of its signal is small, negative side body-grounding is employed. A terminal board 18 is configured to be molded by a resin, and two pieces total of a motor relay 11Y1 and a motor relay 11Y2 are furnished on the resin board. Also, a resolver rotor 12 for detecting the magnetic pole is pressed in to a motor shaft 2 in the center part of the terminal board 18.

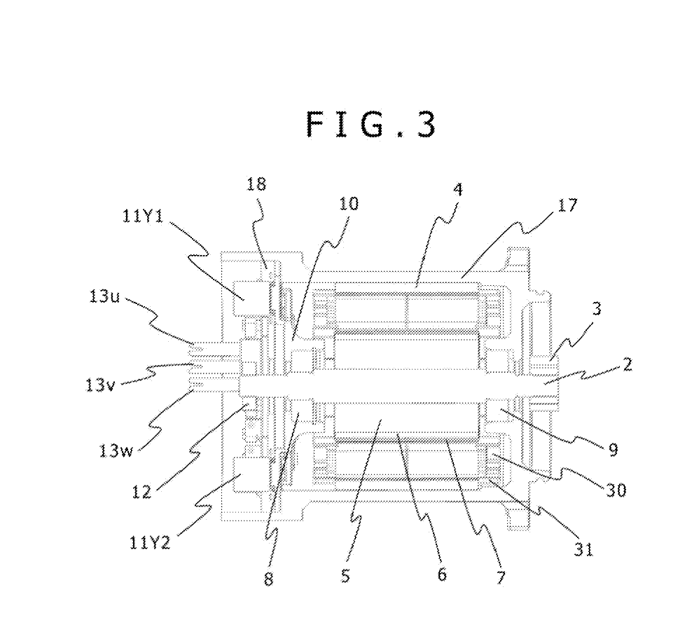

The cross-sectional structure of the motor unit 100 will be described using FIG. 3. A stator core 4 is fixed to the aluminum housing 17 by shrinkage fitting. In the stator core 4, coils 30 are wound around resin bobbins 31. In the inner circumferential section of the stator core 4, a rotor core 5 is arranged on the basis of the shaft 2, a magnet 6 is disposed in the outer circumferential section of the rotor core 5, and a magnet cover 7 is arranged in the outer circumferential section of the magnet 6. The magnet cover 7 is formed of a material of a non-magnetic body. With bearings of the shaft 2, an F bearing 9 disposed on the output shaft side is held by the aluminum housing 17. Also, a gear 3 for power transmission is arranged at the distal end of the output shaft. With the bearing opposite to the output side, an R bearing 8 is arranged, and an outer ring of the R bearing 8 is held by a bearing cover 10. The bearing cover 10 is screw (not illustrated)-fixed to the aluminum housing 17 using screw holes same to those for the terminal board 18. On the terminal board 18, as described above also, the three-phase terminals which are the U-phase terminal 13u—the W-phase terminal 13w for electrically connecting to the control unit 200 are arranged. Also, the two motor relays 11Y1, 11Y2 for electrically opening/closing the neutral point of the three-phase winding and relay power source terminals for controlling these motor relays are arranged. Even if these relays are replaced by semiconductor switches, a same effect is obtained.

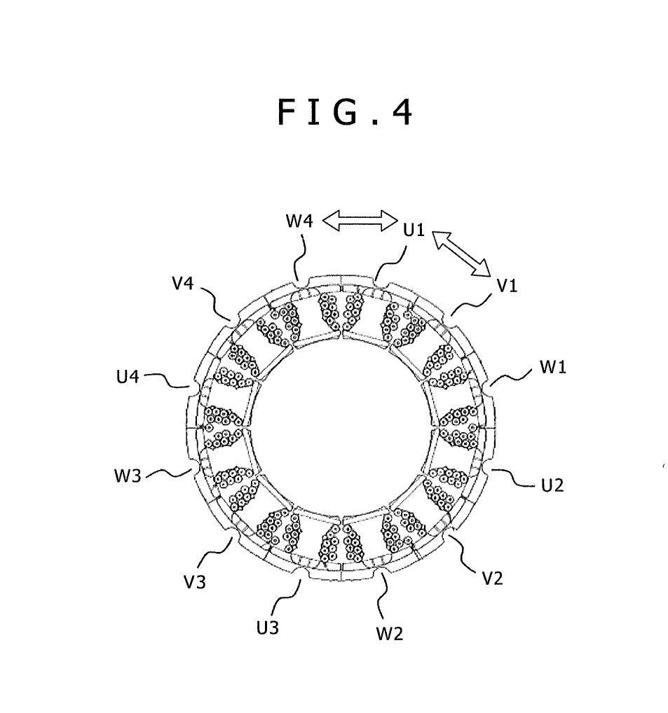

FIG. 4 shows the phase arrangement of the 8 pole-12 slot structure. In 8 poles-12 slots, because the electric phase difference of neighboring teeth is 120 degrees, next to the U-phase is either the V-phase or the W-phase. In this FIG. 3, the V-phase is defined clockwise. As a result, because one set of the three-phase winding can be formed by 90 degrees of the mechanical angle, as the three-phase winding, four coils may be connected in series for one phase, and there are three ways of the connecting methods in total including two in series and two in parallel, as well as four in parallel. For example, in the case of this structure, because next to the U-phase coil is the V-phase coil and the opposite side is the W-phase coil, when contact between the coils occurs, the phase short circuit comes to occur.

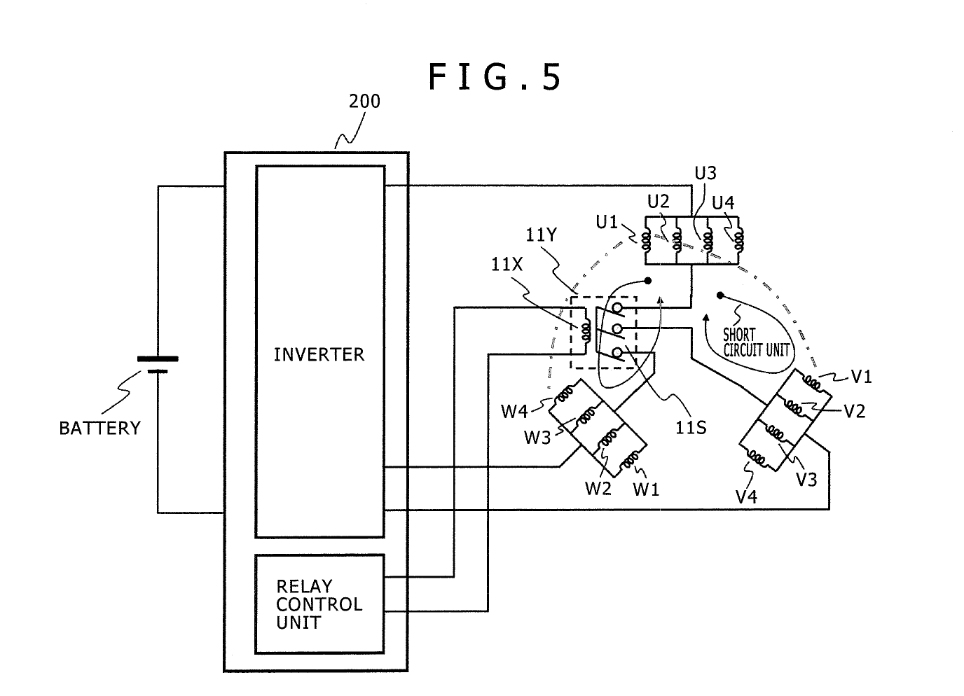

Next, possibility of the phase short circuit inside the motor will be described using FIG. 5. First, the configuration will be described. This motor structure shows a structure in which one motor relay 11Y is disposed at the neutral point of the three phases in the winding connection of the 8 pole-12 slot structure and the structure of four in parallel in one phase shown above. The motor relay is formed of a contact point 11S for turning on/off the electric connection and an exciting winding 11X for controlling it. This exciting winding is configured to be controlled to be capable of on/off operation by electrically connected to a relay control unit CON. Also, the three-phase windings of the motor are connected to an inverter INV. The relay control unit CON and the inverter INV are accommodated in the control unit 200. Also, to the control unit 200, a battery Bt is connected.

The phase short circuit occurs, in the case of the U-phase winding for example out of the three-phase windings, by electrically connecting to the V-phase winding or the W-phase winding. As the mechanism of occurrence, a case a foreign object is mixed in to the gap between the phases, a case caused by generation of a mechanical defect by rubbing of electric wires each other and deterioration of insulation coating, and the like can be conceived, however, the level of the generation frequency is substantially low. However, once the phase short circuit occurs, the control unit cannot control it, and therefore disconnection of the phase short circuit section is required. This motor relay 11Y is of normal-open type, and is switched off normally. In electrically powered assisting, the motor relay 11Y is switched on for action. Accordingly, because the loss is generated due to constant flow of the electric current, cooling is important. As shown in FIG. 4, because the U-phase coil and the V, W-phase coils are adjacent to each other, the phase short circuit possibly occurs. The chain line shown in FIG. 5 shows the phase short circuit. When the phase short circuit occurs between the U-phase coil and the V-phase coil, in the steering motion, the short circuit current flows along a loop shown by an arrow of the solid line through the neutral point. The same is true also with the W-phase. When this phase short circuit occurs, in steering motion, the short circuit current flows at the short circuit section because of the counter electromotive voltage of the motor, and a force of impeding the steering motion is generated. Generation of the short circuit current can be prevented by disconnecting the motor relay 11Y. However, when the motor relay 11Y is disconnected, the motor motion becomes impossible, therefore the steering assist becomes impossible, and the driver comes to feel inconvenience in the steering motion. Therefore, the present embodiment is configured to form two independent motors within the motor, and the motor relays are arranged at the neutral points of the respective motors. With this configuration, the control circuit suitable to the mechanically and electrically integrated type can be made compact with one inverter.

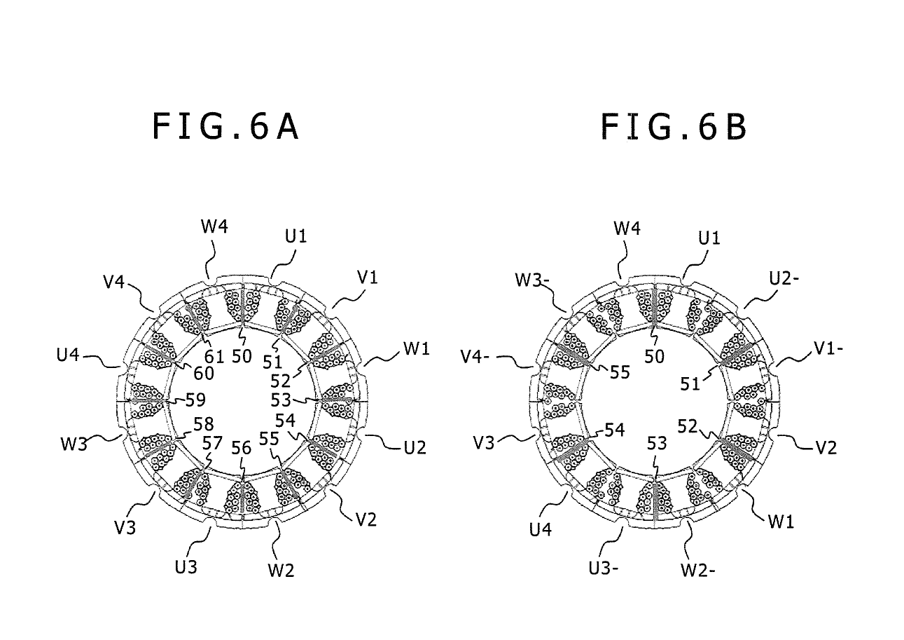

FIG. 6A shows the phase arrangement of the 8 pole-12 slot structure, and FIG. 6B shows the phase arrangement of the 10 pole-12 slot/14 pole-12 slot structure, which are widely used for an electric power steering. With the 8 pole-12 slot structure, because the adjacent phase is the other phase as described above, it is effective to insert insulation paper sheets 50-61 to all of the respective slots as shown in the drawing to mechanically prevent the phase short circuit. On the other hand, with the 10 pole-12 slot structure, because two same phase coils are arrayed continuously, the number of the insulation paper sheets 50-55 of the respective phases becomes a half. However, when the insulation paper is arranged between the slots, the area occupancy rate of the coil drops and the cost increases, and therefore it is necessary to minimize the number of use.

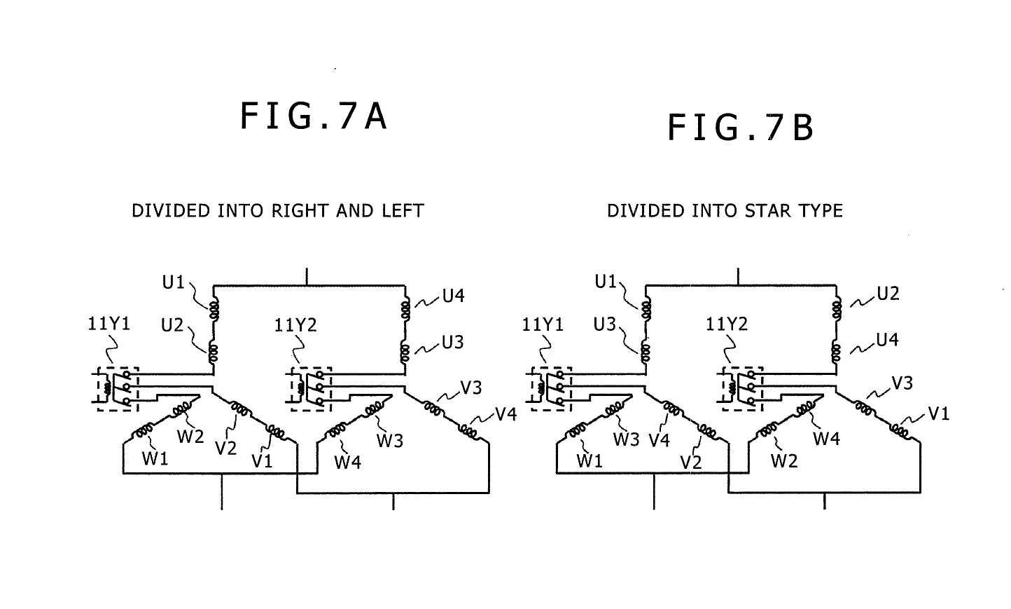

In FIG. 7A and FIG. 7B, two similar kinds of connection methods are shown in which the motor winding is formed of two parallel circuits. FIG. 7A shows a mechanical structure of the motor in which the right half and the left half are mechanically divided. Because this configuration can mechanically divide the motor into the right and left, the locations where the phase short circuit may possibly occur are two locations between W4 and U1 and between W2 and U3, and therefore the insulation paper can be reduced to 50 and 56. In the star-type arrangement of FIG. 7B, although the possibility of the phase short circuit within the Y type wire connection (star type wire connection) lowers, the possibility of the phase short circuit with the other Y type wire connection comes out. In this case, the short circuit current is considered to increase because the short circuit passage becomes long. In order to prevent the phase short circuit straddling the Y type wire connections, the insulation paper is necessary between the respective slots.

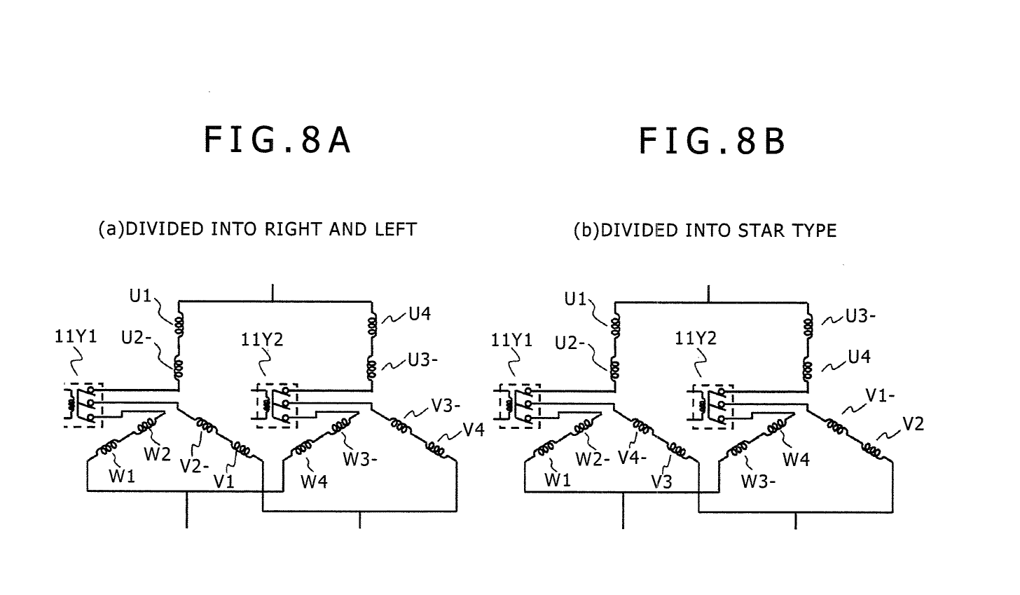

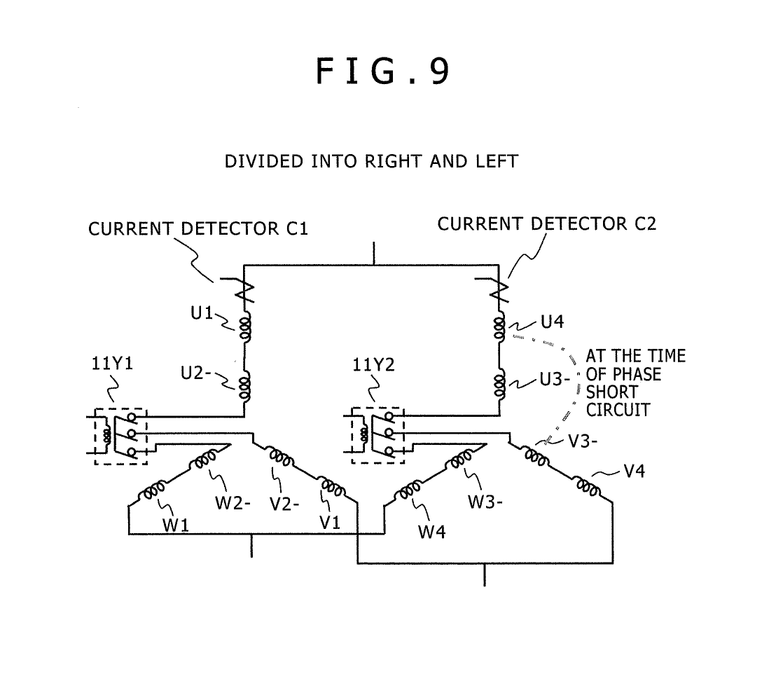

In FIG. 8A and FIG. 8B, two methods are shown similarly to FIG. 7A and FIG. 7B with the wire connection structures of 10 poles-12 slots and 14 poles-12 slots. FIG. 7A shows a case two motor windings are mechanically divided, and FIG. 7B shows a case the respective phase windings are disposed in a star type. In these cases also, in the case of FIG. 7A in which the motor windings are mechanically divided into the right and left, the insulation paper can be simplified to two sheets, and, in the case of FIG. 7B, even when one motor is driven, the motor can rotate with good balance, however, six sheets of the insulation paper are required ideally. Referring to FIG. 9, an example of a means for detecting occurrence of the phase short circuit of a motor divided into two systems will be described. The circuit configuration shows the right and left divided type that is shown in FIG. 8A. In the two independent Y type wire connections, the neutral points are independent from each other and are not electrically connected to each other. Also, current detectors C1 and C2 capable of simultaneously measuring the phase current of the same phases are disposed, and are configured to be capable of monitoring the motor current of the respective Y type wire connections.

For example, because the U4 coil and the V3 coil are disposed so as to be adjacent to each other, if the phase short circuit occurs at the boundary face thereof, the short circuit of the chain line shown in FIG. 9 occurs. As a result, the phase resistance of the U-phase coil and the V-phase coil drops, and imbalance of the three phases occurs. As a result, a phenomenon that the U-phase current flowing through the current detector C2 increases occurs. Further, dispersion of the potential of the neutral points of two Y type wire connections occurs. Therefore, when occurrence of the phase circuit is detected from the imbalance of the phase current or is detected from variation of the potential of the neutral points, which Y type wire connection motor has caused the phase short circuit can be detected.

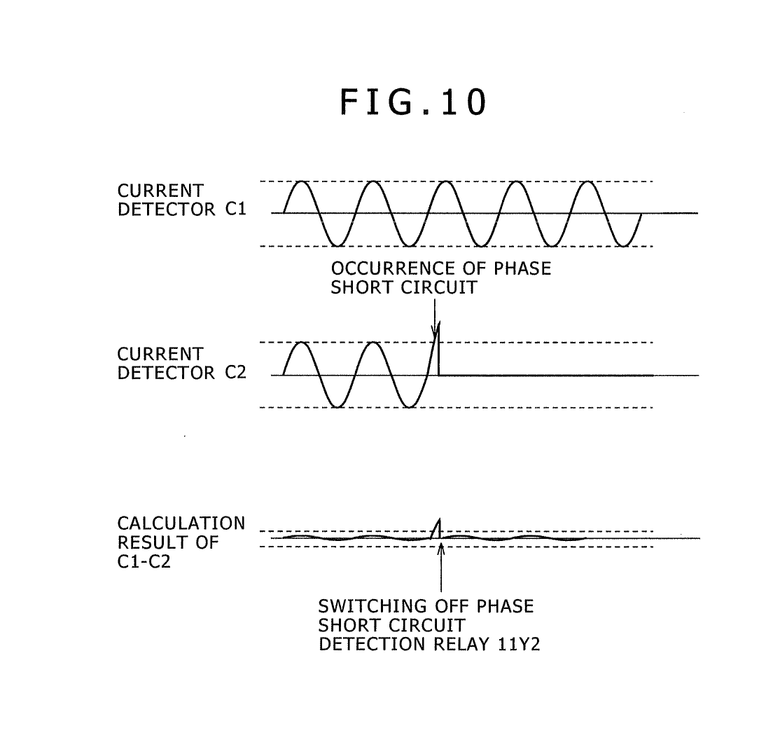

FIG. 10 shows a timing chart of detection of occurrence of the phase short circuit from variation of the phase current. The current flowing through the each current detector C1 and C2 is shown. Although the current of the same magnitude flows normally, when the phase short circuit occurs, because the phase resistance drops, the phase current increases. On the control circuit side, the magnitude of the current is compared constantly, when the current is imbalanced, the motor of the side the current value has increased is determined to have caused the phase short circuit, and the motor relay 11Y2 is turned off.

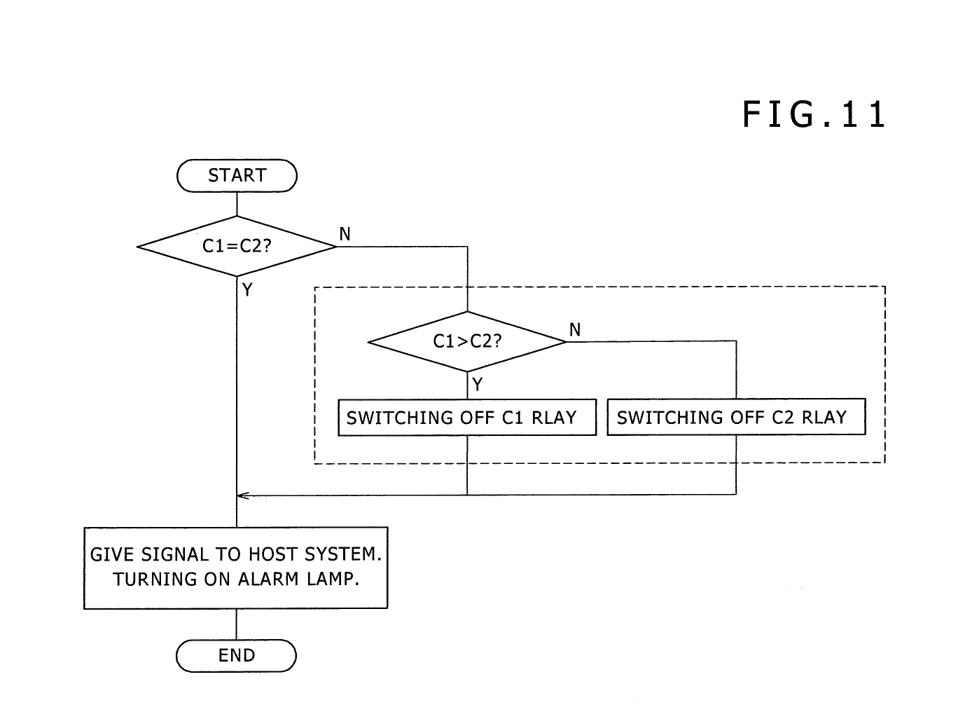

FIG. 11 shows a flowchart of a detection algorithm thereof. For the detection, the currents flowing through the respective Y type wire connections are compared to each other, and the motor relay in which the current of the current detector is larger is turned off. It is configured that the abnormality is thereafter reported to the host system and the abnormality is reported to the driver.

In the above description, only the current value was compared, however, because the phase also changes actually, the phase of the phase current also can be used as a determination criterion.

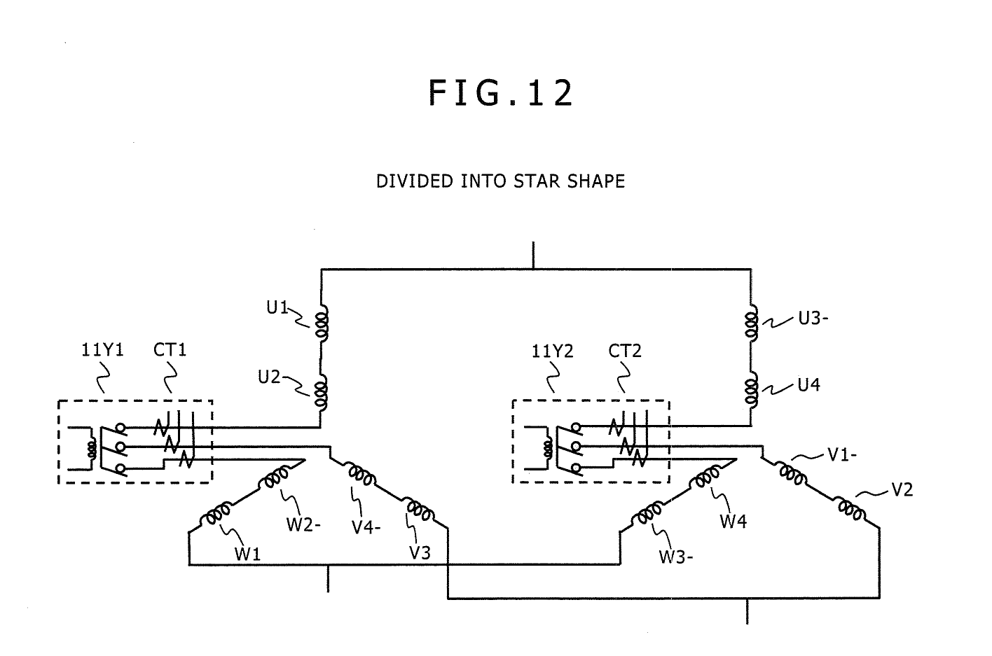

Although a structure using two current detectors was described above, description will be made for that showing a case one current detector is arranged for each phase. FIG. 12 shows a structure provided with a current detector in the motor relay at the neutral point. Inside the motor relay 11Y1, the three-phase current detector is arranged, and the currents flowing in the respective phases are added together. Normally, the added result of the three-phase current is constantly zero; however, when the added result comes out to be other than zero, the relay unit is operated so as to be turned off. Similarly, the same is true also with the motor relay 11Y2. By disposing the motor relays having the structure described above at the respective neutral points, abnormality of the motor including the phase short circuit is detected, the input of the current from the inverter is disconnected, and the short circuit of the counter electromotive voltage generated at the time of the phase short circuit is disconnected.

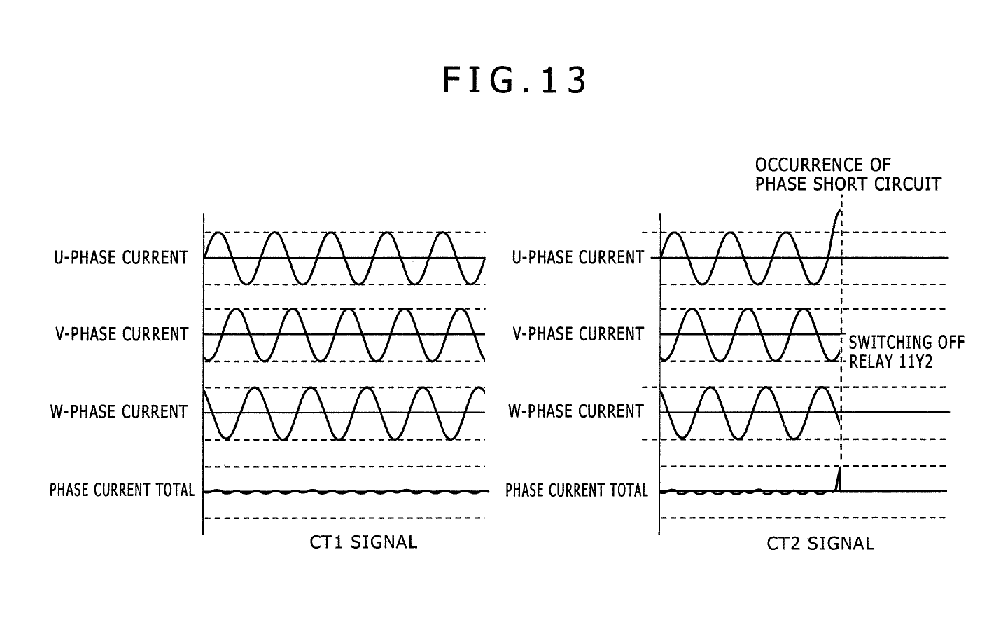

FIG. 13 shows a timing chart thereof. The signal of the three-phase current detector CT2 is the added result of the current of each phase, and is normally zero. However, because the total amount of the phase current varies when the phase short circuit occurs, the signal of the three-phase current detector CT2 acts to turn off an exciting coil of the motor relay when the variation occurs.

As described above, when abnormality occurs in the coil of the motor in the electric power steering system and the motor assist stops, the steering motion becomes impossible and the steering system is forced to be operated by manpower only, however, when elderly drivers increase from now on, the steering motion by manpower only loses comfort in driving. Therefore, in the present embodiment, in an electric power steering system mechanically and electrically integrated and compactly designed, motor winding is formed of plural numbers of independent three-phase windings which are configured to be of Y wire connection, motor relays are disposed at neutral points thereof, means for detecting the phase current are arranged, a motor where abnormality has occurred is identified out of plural motors from the level of the current value, the phase, or the potential of the neutral point, a relay arranged at the neutral point is electrically disconnected, and thereby a system is obtained which can continue the electric assist by a motor capable of normal motion. Also, because the motor relay is divided into plural number of pieces, the volume per one piece reduces, and therefore the degree of freedom of the installation layout of the relays improves in such a structure of the mechanically and electrically integrated type with a large restriction in the layout space.

### Second Embodiment

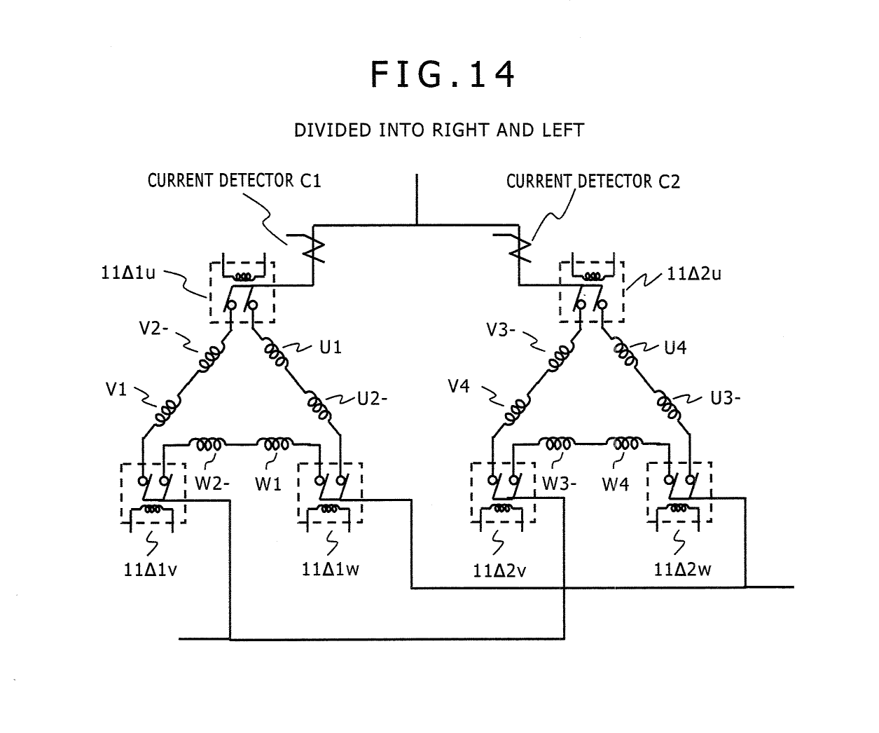

FIG. 14 shows a motor configuration drawing of the triangular wire connection (delta wire connection) in which relays are arranged at the connecting points of the respective phases, which is different from those described in FIG. 7A, FIG. 7B, FIG. 8A, FIG. 8B in which the relays are arranged at the neutral points of the Y wire connections.

The configuration of FIG. 14 will be described. The triangular wire connection is formed of two independent three-phase windings. With the coils of the respective phases of the U-phase, the V-phase, the W-phase, two coils are connected in series. With the relay, one arranged between the U-phase and the V-phase is a motor relay 11Δ1u, one arranged between the V-phase and the W-phase is a motor relay 11Δ1v, and similarly, one arranged between the W-phase and the U-phase is a motor relay 11Δ1w. These relays are configured to execute the on/off motion by that the current flows through the exciting winding by an electric signal (not illustrated). When the current does not flow through the exciting winding, the switches of these relays are open, and the coils of the respective phases are in a disconnected state. Similarly, in the other triangular winding also, relays are arranged at the connecting sections of the respective phases.

With the relay, although a mechanical relay structure was described, because a relay using a semiconductor also has a similar effect, it is preferable to selectively use the relay according to the configuration of the motor and the control circuit. Also, whichever type of the relay is used, when the relay is arranged on the control circuit side, control is easier from the viewpoint of the temperature control. Therefore, it is preferable to arrange the relay on the control circuit side from the aspect of the reliability also.

The two independent triangular wire connections are configured so that the relays of the same phase are connected to each other and that the windings of the respective phases are connected in series. Also, with the current detector for detecting abnormality of the independent two three-phase wire windings, a pair of the current sensors were arranged in some phase of the three-phase windings. In the case of the drawing, the current detectors were arranged in the wiring sections of the relays that are connected to the connecting sections of the U-phase and the V-phase. The function of the current detectors C1 and C2 is a role of a detector of disconnecting a relay of the abnormal current watching the timing of occurrence of imbalance in the amount of the current flowing through each current detector when the internal short circuit occurs in the three-phase winding of one side although a generally same amount of the current flows normally because the windings are connected in parallel. By simultaneously disconnecting three relays arranged within the triangular wire connection at the time of occurrence of the abnormality, there is an effect of suppressing generation of the brake torque of the short circuit current by the internal short circuit of the motor. Although the configuration of using six relays was described in this drawing, when one having a structure of forming plural relays into one module is used, the flow of the current can be controlled by less number of pieces of relays.

Although the above embodiments were described with an example of the electric power steering of the mechanically and electrically integrated type, the present invention can be applied also to an electric power steering system in which the control circuit and the motor are formed separately. Also, it will be needless to mention that the present invention can be applied also to a brake-assist motor, a main motor for a hybrid automobile, a motor for an electric automobile, and the like in addition to a motor related to steering which is used for an automobile and requires reliability.

What is claimed is:

1. An electric actuator forming one three-phase winding by connecting a plurality of coils including a U-phase, a V-phase, and a W-phase,
wherein the three-phase winding includes a circuit in which a plurality of winding groups obtained by connecting the U-phase, the V-phase, and the W-phase each other are connected in parallel,
wherein a connecting section where windings of respective phases of the winding group are connected to each other includes a switching unit capable of independently disconnecting each winding group from other winding groups, and
wherein, when a winding group is disconnected from the other winding groups by the switching unit, remaining winding groups are connected in parallel and thereby one three-phase winding is formed.

2. The electric actuator according to claim 1, wherein
the winding group is formed of a Y type wire connection, and the connecting section is a neutral point of the Y type wire connection.

3. The electric actuator according to claim 1, wherein
the winding group is formed of a triangular wire connection, and the connecting sections are portions where the U-phase, the V-phase, and the W-phase are connected to each other.

4. The electric actuator according to claim 1, wherein
the winding group is formed of winding units of minimum phases adjacent to each other, and is formed by connecting the respective winding groups in series or in parallel.

5. The electric actuator according to claim 1, wherein
an electric insulator is disposed in a boundary between the winding groups.

6. A method for controlling the electric actuator according to claim 1, the winding groups being connected in parallel, the method comprising:
creating a signal on the basis of imbalance in an amount of current flowing through same phase windings of different winding groups; and
disconnecting an exciting winding current based on the signal.

7. A method for controlling the electric actuator according to claim 2, the winding groups being connected in parallel, the method comprising:
creating a signal on the basis of imbalance in potential of neutral points of different winding groups; and
disconnecting an exciting winding current based on the signal.

8. A method for controlling the electric actuator according to claim 1, the winding groups being connected in parallel, the method comprising:
creating a signal on the basis of imbalance in a total amount of phase current of three-phase winding of respective winding groups; and
disconnecting an exciting winding current based on the signal.

9. A method for controlling the electric actuator according to claim 2, the winding groups being connected in parallel, the method comprising:
measuring current of each phase connected to a neutral point by detectors included in the switching unit; and
interrupting current of an exciting coil of the switching unit when the total amount of phase current thereof does not become zero.
